(19) United States
(12) Patent Application Publication
(10) Pub. No.: US 2025/0008464 A1
(43) Pub. Date: Jan. 2, 2025

(54) TIMING ADVANCE DETERMINATION METHOD AND APPARATUS

(71) Applicant: HUAWEI TECHNOLOGIES CO., LTD., Shenzhen (CN)

(72) Inventors: Tianhang YU, Hangzhou (CN); Xiaocheng LIU, Shenzhen (CN); Hejia LUO, Hangzhou (CN); Rong LI, Boulogne Billancourt (FR); Jun WANG, Hangzhou (CN)

(21) Appl. No.: 18/828,666

(22) Filed: Sep. 9, 2024

Related U.S. Application Data
(63) Continuation of application No. PCT/CN2023/079224, filed on Mar. 2, 2023.

(30) Foreign Application Priority Data
Mar. 9, 2022 (CN) 202210224939.0

(51) Int. Cl. H04W 56/00; H04W 84/06

(52) U.S. Cl. CPC H04W 56/0045; H04W 84/06

(57) ABSTRACT

A timing advance determining method includes obtaining, by a first communication apparatus, first information about a reference time signal, determining, based on the first information, a reference time at which the reference time signal is generated, and determining a timing advance based on the reference time and a first time at which the first communication apparatus receives a downlink signal. The reference time signal is a periodic signal.

### CROSS-REFERENCE TO RELATED APPLICATIONS

This application is a continuation of International Application No. PCT/CN2023/079224, filed on Mar. 2, 2023, which claims priority to Chinese Patent Application No. 2022/10224939.0, filed on Mar. 9, 2022, the disclosures of the aforementioned applications are hereby incorporated by reference in their entireties.

### TECHNICAL FIELD

This application relates to the field of wireless communication, and in particular, to a timing advance determining method and an apparatus.

### BACKGROUND

In non-terrestrial networks (NTN) scenario, there is a long transmission delay between a terminal device and a satellite, and because a communication cell covers a large area, transmission delays between terminal devices in different locations and a satellite are different. In addition, as communication networks gradually operate in high frequency bands, there are increasingly high requirements for timing advances in communication, making uplink synchronization between a terminal device and a satellite more difficult.

Uplink synchronization requires that an uplink signal sent by a terminal device can be synchronized with uplink timing at a satellite when arriving at the satellite. Usually, terminal devices in different locations can learn of corresponding information about timing advances (TA) and frequency offsets in random access procedures, to determine to send uplink signals to a satellite at corresponding moments. In this case, all the uplink signals from the terminal devices can be synchronized with uplink timing at the satellite when arriving at the satellite. However, the timing advances cannot be accurately determined by using a current solution, and consequently it cannot be ensured that the terminal devices implement uplink synchronization with the satellite.

Therefore, a solution of accurately determining a timing advance between a terminal device and a satellite is urgently needed, to ensure that the terminal device implements uplink synchronization with the satellite.

### SUMMARY

One or more embodiments of the present disclosure disclose a timing advance determining method and an apparatus that accurately determine a timing advance between a terminal device and a satellite, so as to ensure that the terminal device implements uplink synchronization with the satellite.

According to a first aspect, an embodiment of this application provides a timing advance determining method. The method may be performed by a first communication apparatus, or may be performed by a processor in a first communication apparatus, or may be performed by a chip in which the processor is installed. This is not limited. In some embodiments, the method includes the following steps: A first communication apparatus obtains first information about a reference time signal, where the reference time signal is a periodic signal; the first communication apparatus determines, based on the first information, a reference moment at which the reference time signal is generated; and the first communication apparatus determines a timing advance based on the reference moment and a first moment at which the first communication apparatus receives a downlink signal.

In this embodiment of this application, the first communication apparatus determines, based on the first information, the reference moment at which the reference time signal is generated. Because the reference time signal is periodic, the first communication apparatus can accurately calculate a timing advance based on reference moments in different periodicities and moments at which downlink signals are received, further ensuring that the terminal device implements uplink synchronization.

In some embodiments, the first communication apparatus may be a terminal device, a processor in a terminal device, or an apparatus capable of supporting a terminal device to implement the calculation function, for example, a chip system. The apparatus may be installed in or used in conjunction with a terminal device. Therefore, a specific form of the first communication apparatus that implements the calculation function is not limited in this application.

The reference time signal is periodic. Therefore, when the first communication apparatus receives a downlink signal in a periodicity of a reference time signal, it indicates that the reference time signal is associated with the downlink signal, and it also indicates that a reference moment at which the reference time signal is generated is associated with a moment at which the first communication apparatus receives the downlink signal. Further, the first communication apparatus may determine a timing advance based on the associated reference moment and the moment at which the downlink signal is received.

For example, a network device generates a reference time signal, and determines a first reference moment at which the reference time signal is generated. Then, the network device sends first information about the reference time signal to a terminal device. The terminal device can also determine a first reference moment based on the first information. In this case, the first reference moments determined by the network device and the terminal device are synchronized with each other. Therefore, in a periodicity of the reference time signal, the network device sends a first downlink signal to the terminal device. The terminal device receives the first downlink information, and may determine a timing advance based on the first reference moment and a moment at which the first downlink signal is received. The first reference moment is referred to as a reference moment associated with the first downlink signal.

In some embodiments, the first information includes a periodicity of the reference time signal; or the first information includes a first index, and the first index indicates a periodicity of the reference time signal.

In some embodiments, the first communication apparatus can flexibly and accurately obtain the periodicity of the reference time signal, ensuring accuracy of the associated reference moment at which the first reference signal is generated.

In some embodiments, the periodicity of the reference time signal is greater than or equal to a first delay; and the first delay is a transmission delay between the first communication apparatus and a second communication apparatus, or the first delay is a difference between a maximum value and a minimum value of a transmission delay between the first communication apparatus and a second communication apparatus.

In this embodiment of this application, the periodicity of the reference time signal may be expressed as a time interval between adjacent reference time signals that are generated.

In some embodiments, when the first delay is the transmission delay between the first communication apparatus and the second communication apparatus, the time interval between adjacent reference time signals is greater than or equal to the transmission delay, ensuring that the first communication apparatus can accurately calculate the transmission delay and then calculate an accurate timing advance.

In some embodiments, the periodicity ΔT₁ₚₚₛ of the reference time signal meets that a value of Num_SFN/(ΔT₁ₚₚₛ/L_SFN) is an integer, where Num_SFN represents a quantity of system frames in one frame cycle, and L_SFN represents duration of the system frame.

In some embodiments, it can be ensured that intervals between boundaries of system frames with a same index and associated reference time signals are the same in different cycles of system frames (for example, each cycle includes 1024 system frames) sent by the second communication apparatus. In other words, in different cycles, intervals between boundaries of system frames with a same index and associated reference time signals are all a same interval value. The interval value may be agreed upon by the first communication apparatus and the second communication apparatus, or may be accurately indicated to the first communication apparatus by using an instruction.

In some embodiments, the method further includes: The first communication apparatus receives second information, where the second information indicates the quantity of system frames in the one frame cycle.

In some embodiments, the first communication apparatus can accurately learn of the quantity of system frames in the one frame cycle.

In some embodiments, the first information further includes a first field, and the first field indicates an interval between a starting moment of an air interface frame in a frame cycle and the reference moment; or an interval between a starting moment of an air interface frame in a frame cycle and the reference moment is agreed upon in advance, where a value of the interval between the starting moment of the air interface frame and the reference moment is greater than or equal to 0 and less than or equal to the periodicity of the reference time signal. Optionally, the interval between the starting moment of the air interface frame in the frame cycle and the reference moment may be agreed upon by the first communication apparatus and the second communication apparatus, or may be predefined in a standard.

If the interval between the starting moment of the air interface frame in the frame cycle and the reference moment is equal to 0, the interval between the starting moment of the air interface frame and the reference moment may not need to be indicated to the first communication apparatus, reducing signaling overheads, shortening a calculation process in which the first communication apparatus determines the timing advance, and reducing system overheads.

In some embodiments, the first communication apparatus can accurately learn of the value of the interval between the starting moment of the air interface frame in the frame cycle and the reference moment, ensuring that the first communication apparatus can accurately calculate the timing advance subsequently. When the periodicity ΔT₁ₚₚₛ of the reference time signal does not meet that the value of Num_SFN/(ΔT₁ₚₚₛ/L_SFN) is an integer, this method may be alternatively used.

In some embodiments, the periodicity ΔT₁ₚₚₛ of the reference time signal meets that a value of 1 s/ΔT₁ₚₚₛ is an integer.

In some embodiments, a quantity of reference time signal periodicities included in one second is exactly an integer, and intervals between adjacent 1 pps signals and reference time signals that are closest to the adjacent 1 pps signals are the same, avoiding an inconsistency between reference time signals at intervals of ΔT₁ₚₚₛ that are generated by a sending end (for example, the second communication apparatus) and a receiving end (for example, the first communication apparatus) based on 1 pps, and ensuring accuracy of the calculated timing advance.

In some embodiments, the method further includes: The first communication apparatus receives third information, where the third information indicates information about an interval between the reference time signal and a 1 pulse per second signal, and the reference time signal is generated based on the 1 pulse per second signal.

In some embodiments, the first communication apparatus can accurately learn of the information about the interval between the reference time signal and the 1 pulse per second signal (or a relative positional relationship between the reference time signal and the 1 pulse per second signal), for example, an interval between the reference moment and a starting moment of a closest preceding 1 pulse per second signal, or an interval between the reference moment and an ending moment of a closest succeeding 1 pulse per second signal. When the periodicity ΔT₁ₚₚₛ of the reference time signal does not meet that the value of 1 s/ΔT₁ₚₚₛ is an integer, this method may be alternatively used.

In some embodiments, information related to the interval between the reference time signal and the 1 pulse per second signal may also be indicated to the first communication apparatus by using the third information. For example, the information related to the interval includes compression of the interval. The compression may be:

$$interval - ⌊ \frac{interval}{Δ {T}_{1 pps}} ⌋ \times Δ {T}_{1 pps} .$$

Therefore, the first communication apparatus can indirectly obtain a value of the interval based on the compression of the interval, alternatively.

In some embodiments, the reference time signal is generated based on a 1 pulse per second signal.

In some embodiments, because edges of 1 pulse per second signals are strictly aligned, 1 pulse per second signals output by apparatuses in different geographical locations (for example, the first communication apparatus and the second communication apparatus) are synchronized with each other. Therefore, if the reference time signal is generated based on a 1 pulse per second signal, it can be ensured that reference time signals generated by apparatuses in different geographical locations are also synchronized with each other.

In some embodiments, the method further includes: The first communication apparatus receives first indication information, where the first indication information indicates information about a module that generates the 1 pulse per second signal.

In some embodiments, the first communication apparatus can accurately learn of a specific module that is in a communication apparatus sending the first indication information and that provides the 1 pps signal. The first communication apparatus may also use a 1 pps signal provided by a same module for generation of a reference time signal. In this case, the following can be ensured: Reference time signals generated by the two communication apparatuses are consistent, therefore reference moments determined by the two communication apparatuses are also consistent, and finally, the timing advance determined by the first communication apparatus is accurate.

In some embodiments, the method further includes: The first communication apparatus receives fourth information, where the fourth information indicates a frame structure, and the frame structure is used for determining an interval between a starting moment of an air interface frame in a frame cycle and a sending moment of the downlink signal.

In some embodiments, when receiving the fourth information, the first communication apparatus can accurately learn of, based on the frame structure indicated by the fourth information, the interval between the starting moment of the air interface frame in the frame cycle and the sending moment corresponding to the received downlink signal, then accurately calculate the transmission delay between the first communication apparatus and the second communication apparatus based on the interval, and finally accurately determine the timing advance.

In some embodiments, the timing advance satisfies the following formula:

$$T A = 2 \times ( T 1 - T f - T p ) ,$$

where TA is the timing advance, T1 is an interval between the reference moment and the first moment at which the first communication apparatus receives the downlink signal, Tf is the interval between the starting moment of the air interface frame in the frame cycle and the reference moment, Tp is the interval between the starting moment of the air interface frame in the frame cycle and the sending moment of the downlink signal, TA, T1, Tf, and Tp are all values greater than or equal to 0, and × is a multiplication sign.

In some embodiments, the first communication apparatus can accurately calculate the timing advance, ensuring that the first communication apparatus implements uplink synchronization.

According to a second aspect, an embodiment of this application provides a timing advance determining method. The method may be performed by a second communication apparatus, or may be performed by a processor in a second communication apparatus, or may be performed by a chip in which the processor is installed. This is not limited. The method specifically includes the following steps: A second communication apparatus determines first information about a reference time signal, where the reference time signal is a periodic signal, and the first information is used for determining a reference moment at which the reference time signal is generated; and the second communication apparatus sends the first information.

In this embodiment of this application, the second communication apparatus first determines the first information about the reference time signal. Because the reference time signal is periodic, a reference time signal generated by a receiving end receiving the first information (for example, a first communication apparatus) is synchronized with the reference time signal generated by the second communication apparatus. To be specific, a reference moment determined by the receiving end is consistent with the reference moment determined by the second communication apparatus. In this case, the receiving end (for example, a first communication apparatus) can accurately calculate a timing advance based on reference moments in different periodicities and moments at which downlink signals are received, implementing uplink synchronization with the second communication apparatus.

In some embodiments, the second communication apparatus may be a network device, for example, a satellite or a base station, may be a processor in a network device, or may be an apparatus capable of supporting a network device to implement the calculation function, for example, a chip system. The apparatus may be installed in or used in conjunction with a network device. Therefore, a specific form of the second communication apparatus that implements the function is not limited in this application.

In some embodiments, that a second communication apparatus determines first information about a reference time signal includes: The second communication apparatus determines a periodicity of the reference time signal based on positional information between the second communication apparatus and a first communication apparatus and a first mapping, where the first mapping is a correspondence between the positional information and the periodicity of the reference time signal.

In some embodiments, the second communication apparatus can flexibly and accurately obtain, based on the positional information between the first communication apparatus and the second communication apparatus and according to the first mapping, the periodicity of the reference time signal corresponding to the first communication apparatus.

The positional information between the first communication apparatus and the second communication apparatus may include one or more of a difference between heights of the first communication apparatus and the second communication apparatus, an angle at which the first communication apparatus and the second communication apparatus communicate, or geographical coordinates of the first communication apparatus and the second communication apparatus. Based on the positional information between the first communication apparatus and the second communication apparatus, a distance between the two communication apparatuses can be calculated, and then based on the distance between the two communication apparatuses, the corresponding periodicity of the reference time signal can be flexibly determined, ensuring that the first communication apparatus located in a different geographical location can accurately obtain the periodicity of the reference time signal, and also ensuring precision of the timing advance determined by the first communication apparatus that is located in a different geographical location.

In some embodiments, the first information includes the periodicity of the reference time signal; or the first information includes a first index, and the first index indicates the periodicity of the reference time signal.

In some embodiments, the first communication apparatus can flexibly and accurately obtain the periodicity of the reference time signal, ensuring accuracy of the associated reference moment at which the first reference signal is generated.

In some embodiments, the periodicity of the reference time signal is greater than or equal to a first delay; and the first delay is a transmission delay between the first communication apparatus and the second communication apparatus, or the first delay is a difference between a maximum value and a minimum value of a transmission delay between the first communication apparatus and the second communication apparatus.

In this embodiment of this application, the periodicity of the reference time signal may be expressed as a time interval between adjacent reference time signals that are generated.

In some embodiments, when the first delay is the transmission delay between the first communication apparatus and the second communication apparatus, the time interval between adjacent reference time signals is greater than or equal to the transmission delay, ensuring that the first communication apparatus can accurately calculate the transmission delay and then calculate an accurate timing advance. When the first transmission delay is greater than the time interval between adjacent reference time signals, the transmission delay spans a plurality of reference time signal periodicities. As a result, it is difficult for the first communication apparatus to accurately calculate the transmission delay, and therefore the timing advance cannot be accurately calculated either.

In some embodiments, the periodicity ΔT₁ₚₚₛ of the reference time signal meets that a value of Num_SFN/(ΔT₁ₚₚₛ/L_SFN) is an integer, where Num_SFN represents a quantity of system frames in one frame cycle, and L_SFN represents duration of the system frame.

In some embodiments, it can be ensured that intervals between boundaries of system frames with a same index and associated reference time signals are the same in different cycles of system frames (for example, each cycle includes 1024 system frames) sent by the second communication apparatus. In other words, in different cycles, intervals between boundaries of system frames with a same index and associated reference time signals are all a same interval value. The interval value may be agreed upon by the first communication apparatus and the second communication apparatus, or may be accurately indicated to the first communication apparatus by using an instruction.

In some embodiments, the method further includes: The second communication apparatus sends second information, where the second information indicates the quantity of system frames in the one frame cycle.

In some embodiments, the receiving end (for example, the first communication apparatus) can accurately learn of the quantity of system frames in the one frame cycle.

In some embodiments, the first information further includes a first field, and the first field indicates an interval between a starting moment of an air interface frame in a frame cycle and the reference moment; or an interval between a starting moment of an air interface frame in a frame cycle and the reference moment is agreed upon in advance, where a value of the interval between the starting moment of the air interface frame and the reference moment is greater than or equal to 0 and less than or equal to the periodicity of the reference time signal. In some embodiments, the interval between the starting moment of the air interface frame in the frame cycle and the reference moment may be agreed upon by the first communication apparatus and the second communication apparatus, or may be predefined in a standard.

If the interval between the starting moment of the air interface frame in the frame cycle and the reference moment is equal to 0, the second communication apparatus may not need to indicate the interval between the starting moment of the air interface frame and the reference moment to the first communication apparatus, reducing signaling overheads, shortening a calculation process in which the first communication apparatus determines the timing advance, and reducing system overheads.

In some embodiments, the first communication apparatus can accurately learn of the value of the interval between the starting moment of the air interface frame in the frame cycle and the reference moment, ensuring that the first communication apparatus can accurately calculate the timing advance subsequently. When the periodicity ΔT₁ₚₚₛ of the reference time signal does not meet that the value of Num_SFN/(ΔT₁ₚₚₛ/L_SFN) is an integer, this method may be alternatively used.

In some embodiments, the periodicity ΔT₁ₚₚₛ of the reference time signal meets that a value of 1 s/ΔT₁ₚₚₛ is an integer.

In some embodiments, a quantity of reference time signal periodicities included in one second is exactly an integer, and intervals between adjacent 1 pps signals and reference time signals that are closest to the adjacent 1 pps signals are the same, avoiding an inconsistency between reference time signals at intervals of ΔT₁ₚₚₛ that are generated by a sending end (for example, the second communication apparatus) and a receiving end (for example, the first communication apparatus) based on 1 pps, and ensuring accuracy of the calculated timing advance.

In some embodiments, the method further includes: The second communication apparatus sends third information, where the third information indicates information about an interval between the reference time signal and a 1 pulse per second signal, and the reference time signal is generated based on the 1 pulse per second signal.

In some embodiments, a communication apparatus receiving the third information (for example, the first communication apparatus) can accurately learn of the information about the interval between the reference time signal and the 1 pulse per second signal (or a relative positional relationship between the reference time signal and the 1 pulse per second signal), for example, an interval between the reference moment and a starting moment of a closest preceding 1 pulse per second signal, or an interval between the reference moment and an ending moment of a closest succeeding 1 pulse per second signal. When the periodicity ΔT₁ₚₚₛ of the reference time signal does not meet that the value of 1 s/ΔT₁ₚₚₛ is an integer, this method may be alternatively used.

In some embodiments, the second communication apparatus may also indicate, by using the third information, information related to the interval between the reference time signal and the 1 pulse per second signal. For example, the information related to the interval includes compression of the interval. The compression may be:

$$interval - ⌊ \frac{interval}{Δ {T}_{1 pps}} ⌋ \times Δ {T}_{1 pps} .$$

Therefore, the first communication apparatus can indirectly obtain a value of the interval based on the compression of the interval, alternatively.

In some embodiments, the reference time signal is generated based on a 1 pulse per second signal.

In some embodiments, because edges of 1 pulse per second signals are strictly aligned, 1 pulse per second signals output by apparatuses in different geographical locations (for example, the first communication apparatus and the second communication apparatus) are synchronized with each other. Therefore, if the reference time signal is generated based on a 1 pulse per second signal, it can be ensured that reference time signals generated by apparatuses in different geographical locations are also synchronized with each other.

In some embodiments, the method further includes: The second communication apparatus sends first indication information, where the first indication information indicates information about a module that generates the 1 pulse per second signal.

In some embodiments, the receiving end (for example, the first communication apparatus) can accurately learn of a module that is in the second communication apparatus and that provides the 1 pps signal for generation of the reference time signal. The first communication apparatus may also use a 1 pps signal provided by a same module for generation of a reference time signal. In this case, the following can be ensured: Reference time signals generated by the two communication apparatuses are consistent, therefore reference moments determined by the two communication apparatuses are also consistent, and finally, the timing advance determined by the first communication apparatus is accurate.

In some embodiments, the method further includes: The second communication apparatus sends fourth information, where the fourth information indicates a frame structure, and the frame structure is used for determining an interval between a starting moment of an air interface frame in a frame cycle and a sending moment of a downlink signal.

In some embodiments, when receiving the fourth information, the first communication apparatus can accurately learn of, based on the frame structure indicated by the fourth information, the interval between the starting moment of the air interface frame in the frame cycle and the sending moment corresponding to the received downlink signal, then accurately calculate the transmission delay between the first communication apparatus and the second communication apparatus based on the interval, and finally accurately determine the timing advance.

According to a third aspect, an embodiment of this application further provides a communication apparatus. The communication apparatus may be used in the first communication apparatus in the first aspect. The communication apparatus may be a terminal device or network device, may be an apparatus (for example, a chip, a chip system, or a circuit) in a terminal device or network device, or may be an apparatus that can be used in conjunction with a terminal device or network device. In some embodiments, the communication apparatus may include modules or units that one-to-one correspond to the methods/operations/steps/actions described in the first aspect. The modules or units may be implemented by hardware circuits, software, or a combination of hardware circuits and software. In some embodiments, the communication apparatus may include a processing unit and a transceiver unit. The processing unit is configured to invoke the transceiver unit to perform receiving and/or sending functions.

In some embodiments, the communication apparatus includes a transceiver module and a processing module. The transceiver module is configured to obtain first information about a reference time signal, where the reference time signal is a periodic signal. The processing module is configured to determine, based on the first information, a reference moment at which the reference time signal is generated. The processing module is further configured to determine a timing advance based on the reference moment and a first moment at which the first communication apparatus receives a downlink signal.

In some embodiments, the first information includes a periodicity of the reference time signal; or the first information includes a first index, and the first index indicates a periodicity of the reference time signal.

In some embodiments, the periodicity of the reference time signal is greater than or equal to a first delay; and the first delay is a transmission delay between the first communication apparatus and a second communication apparatus, or the first delay is a difference between a maximum value and a minimum value of a transmission delay between the first communication apparatus and a second communication apparatus.

In some embodiments, the periodicity ΔT₁ₚₚₛ of the reference time signal meets that a value of Num_SFN/(ΔT₁ₚₚₛ/L_SFN) is an integer, where Num_SFN represents a quantity of system frames in one frame cycle, and L_SFN represents duration of the system frame.

In some embodiments, the transceiver module is further configured to receive second information, where the second information indicates the quantity of system frames in the one frame cycle.

In some embodiments, the first information further includes a first field, and the first field indicates an interval between a starting moment of an air interface frame in a frame cycle and the reference moment; or an interval between a starting moment of an air interface frame in a frame cycle and the reference moment is agreed upon in advance, where a value of the interval between the starting moment of the air interface frame and the reference moment is greater than or equal to 0 and less than or equal to the periodicity of the reference time signal.

In some embodiments, the periodicity ΔT₁ₚₚₛ of the reference time signal meets that a value of 1 s/ΔT₁ₚₚₛ is an integer.

In some embodiments, the transceiver module is further configured to receive third information, where the third information indicates information about an interval between the reference time signal and a 1 pulse per second signal, and the reference time signal is generated based on the 1 pulse per second signal.

In some embodiments, the reference time signal is generated based on a 1 pulse per second signal.

In some embodiments, the transceiver module is further configured to receive first indication information, where the first indication information indicates information about a module that generates the 1 pulse per second signal.

In some embodiments, the transceiver module is further configured to receive fourth information, where the fourth information indicates a frame structure, and the frame structure is used for determining an interval between a starting moment of an air interface frame in a frame cycle and a sending moment of the downlink signal.

According to a fourth aspect, an embodiment of this application further provides a communication apparatus. The communication apparatus may be used in the second communication apparatus in the second aspect. The communication apparatus may be a terminal device or network device, may be an apparatus (for example, a chip, a chip system, or a circuit) in a terminal device or network device, or may be an apparatus that can be used in conjunction with a terminal device or network device. In some embodiments, the communication apparatus may include modules or units that one-to-one correspond to the methods/operations/steps/actions described in the second aspect. The modules or units may be implemented by hardware circuits, software, or a combination of hardware circuits and software. In some embodiments, the communication apparatus may include a processing unit and a transceiver unit. The processing unit is configured to invoke the transceiver unit to perform receiving and/or sending functions.

In some embodiments, the communication apparatus includes a transceiver module and a processing module. The processing module is configured to determine first information about a reference time signal, where the reference time signal is a periodic signal, and the first information is used for determining a reference moment at which the reference time signal is generated. The transceiver module is configured to send the first information.

In some embodiments, where when determining the first information about the reference time signal, the processing module is specifically configured to determine a periodicity of the reference time signal based on positional information between the second communication apparatus and a first communication apparatus and a first mapping, where the first mapping is a correspondence between the positional information and the periodicity of the reference time signal.

In some embodiments, the first information includes the periodicity of the reference time signal; or the first information includes a first index, and the first index indicates the periodicity of the reference time signal.

In some embodiments, the periodicity of the reference time signal is greater than or equal to a first delay; and the first delay is a transmission delay between the first communication apparatus and the second communication apparatus, or the first delay is a difference between a maximum value and a minimum value of a transmission delay between the first communication apparatus and the second communication apparatus.

In some embodiments, the periodicity ΔT₁ₚₚₛ of the reference time signal meets that a value of Num_SFN/(ΔT₁ₚₚₛ/L_SFN) is an integer, where Num_SFN represents a quantity of system frames in one frame cycle, and L_SFN represents duration of the system frame.

In some embodiments, the transceiver module is further configured to send second information, where the second information indicates the quantity of system frames in the one frame cycle.

In some embodiments, the first information further includes a first field, and the first field indicates an interval between a starting moment of an air interface frame in a frame cycle and the reference moment; or an interval between a starting moment of an air interface frame in a frame cycle and the reference moment is agreed upon in advance, where a value of the interval between the starting moment of the air interface frame and the reference moment is greater than or equal to 0 and less than or equal to the periodicity of the reference time signal.

In some embodiments, the periodicity ΔT₁ₚₚₛ of the reference time signal meets that a value of 1 s/ΔT₁ₚₚₛ is an integer.

In some embodiments, the transceiver module is further configured to send third information, where the third information indicates information about an interval between the reference time signal and a 1 pulse per second signal, and the reference time signal is generated based on the 1 pulse per second signal.

In some embodiments, the reference time signal is generated based on a 1 pulse per second signal.

In some embodiments, the transceiver module is further configured to send first indication information, where the first indication information indicates information about a module that generates the 1 pulse per second signal.

In some embodiments, the transceiver module is further configured to send fourth information, where the fourth information indicates a frame structure, and the frame structure is used for determining an interval between a starting moment of an air interface frame in a frame cycle and a sending moment of a downlink signal.

According to a fifth aspect, an embodiment of this application provides a communication apparatus. The communication apparatus includes a processor that is coupled to a memory. The memory stores a computer program or computer instructions. The processor is configured to invoke and run the computer program or computer instructions stored in the memory, so that the processor implements any one of the first aspect or the possible implementations of the first aspect, or implements any one of the second aspect or the possible implementations of the second aspect.

In some embodiments, the communication apparatus further includes the memory. In some embodiments, the memory is integrated with the processor.

In some embodiments, the communication apparatus further includes a transceiver. The processor is configured to control the transceiver to transmit and receive signals, information, data, and/or the like.

According to a sixth aspect, an embodiment of this application provides a communication apparatus. The communication apparatus includes a processor. The processor is configured to invoke a computer program or computer instructions in a memory, so that the processor implements any one of the first aspect or the possible implementations of the first aspect. Alternatively, the processor is configured to perform any one of the second aspect or the possible implementations of the second aspect.

In some embodiments, the communication apparatus further includes a transceiver, configured for the communication apparatus to communicate with another device. For example, the processor is configured to control the transceiver to transmit and receive signals, data, and/or the like.

According to a seventh aspect, an embodiment of this application provides a communication apparatus. The communication apparatus includes a processor. The processor is configured to perform any one of the first aspect or the possible implementations of the first aspect, or to perform any one of the second aspect or the possible implementations of the second aspect.

In some embodiments, the processor implements the method by using a logic circuit. In still another possible implementation, the processor implements the method by using executable instructions.

According to an eighth aspect, an embodiment of this application further provides a computer program product including instructions. When the instructions are run on a computer, the computer is enabled to perform any one of the first aspect or the possible implementations of the first aspect, or to perform any one of the second aspect or the possible implementations of the second aspect.

According to a ninth aspect, an embodiment of this application further provides a computer-readable storage medium, including computer instructions. When the instructions are run on a computer, the computer is enabled to perform any one of the first aspect or the possible implementations of the first aspect, or to perform any one of the second aspect or the possible implementations of the second aspect.

According to a tenth aspect, an embodiment of this application further provides a chip apparatus, including a processor. The processor is configured to invoke a computer program or computer instructions in a memory, so that the processor performs any one of the first aspect or the possible implementations of the first aspect, or to perform any one of the second aspect or the possible implementations of the second aspect.

In some embodiments, the processor is coupled to the memory by using an interface.

According to an eleventh aspect, an embodiment of this application further provides a communication system. The communication system includes a first communication apparatus that is configured to perform any one of the first aspect or the possible implementations of the first aspect, a second communication apparatus that is configured to perform any one of the second aspect or the possible implementations of the second aspect, and a transmission channel that may be configured to implement communication between the first communication apparatus and the second communication apparatus.

For technical effects that can be achieved by any one of the third aspect or the possible implementations of the third aspect, refer to descriptions of technical effects that can be achieved by any one of the first aspect or the possible implementations of the first aspect. For technical effects that can be achieved by any one of the fourth aspect or the possible implementations of the fourth aspect, refer to descriptions of technical effects that can be achieved by any one of the second aspect or the possible implementations of the second aspect. For technical effects that can be achieved by the fifth aspect to the eleventh aspect, refer to descriptions of technical effects that can be achieved by the first aspect or the second aspect. Details are not described herein again.

### BRIEF DESCRIPTION OF DRAWINGS

FIG. 1 is a communication system to which a timing advance determining method is applicable according to an embodiment of this application;

FIG. 2 is a diagram of a 1 pulse per second signal according to an embodiment of this application;

FIG. 3 is a diagram of interaction of a timing advance determining method according to an embodiment of this application;

FIG. 4 is a diagram of timing analysis of a timing advance determining method according to an embodiment of this application;

FIG. 5 is a diagram of a structure of a communication apparatus according to an embodiment of this application;

FIG. 6 is a diagram of a structure of another communication apparatus according to an embodiment of this application; and

FIG. 7 is a simplified diagram of a structure of a chip according to an embodiment of this application.

### DETAILED DESCRIPTION

One or more embodiments of the present application provide a timing advance determining method and an apparatus. The method and the apparatus are based on technical concepts that are the same or similar. Because the method and the apparatus have similar problem-resolving principles, mutual reference may be made to implementations of the apparatus and the method. Repeated parts are not described again.

To facilitate understanding of technical solutions in embodiments of this application, the following first briefly describes existing non-terrestrial communication.

Non-terrestrial communication NTN includes satellite communication, air to ground (ATG) communication, and the like, has advantages such as a wide coverage area, a long communication distance, high reliability, high flexibility, and a high throughput, and is not affected by geographical environments, climatic conditions, and natural disasters. Therefore, non-terrestrial communication has been widely applied in fields such as aviation communication, maritime communication, and military communication. When non-terrestrial communication is introduced to 5th generation mobile communication (5G) new radio (NR) technologies, communication services can be provided for areas that it is difficult for terrestrial networks to cover, such as oceans and forests, and reliability of 5G communication can be enhanced, such as providing more stable and higher-quality communication services for trains, airplanes, and users on these means of transportation, providing more data transmission resources, and supporting more connections. Currently, standards for NR-NTN are being promoted.

Compared with terrestrial communication, NTN communication has different channel characteristics, for example, a long transmission delay and a large doppler (doppler) frequency shift. For example, a round-trip delay of communication using geostationary earth orbit (GEO) satellites (regeneration mode) is 238 ms to 270 ms, a round-trip delay of communication using low earth orbit (LEO) satellites (at an orbital altitude of 1200 km, regeneration mode) is 8 ms to 20 ms, and in an ATG communication scenario, a maximum round-trip delay may also reach 1 ms. In addition, because a cell covered by NTN communication is usually large in area, communication delays between terminal devices in different locations in the cell and a satellite are different.

To reduce differences between the communication delays that are between the satellite and the terminal devices, timing advances need to be used. If no timing advance is used, a terminal device sends uplink information after receiving downlink information sent by the satellite. In this case, when the uplink information arrives at the satellite, there is a time difference between a moment at which the uplink information arrives at the satellite and a moment at which the downlink information is sent. The time difference is a total transmission delay required by uplink and downlink transmission. In addition, because transmission distances between the different terminal devices and the satellite are different, the transmission delays between the different terminal devices and the satellite are also different. In this case, uplink information sent by the different terminal devices arrives at the satellite at different moments, causing interference. Therefore, the satellite requires that signals from the different terminal devices and from a same subframe arrive at basically aligned moments. When timing advances are used, moments at which the uplink information from the terminal devices arrives at the satellite fall within a range of a cyclic prefix (CP). In this case, the satellite can correctly receive uplink data sent by the terminal devices.

Usually, terminal devices in different locations can learn of related information about TAs and frequency offsets when accessing a satellite by using a physical random access channel (PRACH), to determine to send uplink signals to the satellite at corresponding moments. In this case, the uplink signals from the terminal devices can be synchronized with uplink timing at the satellite when arriving at the satellite.

For NTN communication, in a current timing advance determining solution, ephemeris information may be added to a random access procedure, to assist a terminal device in determining information that is about a timing advance TA and a frequency offset and that is related to random access. However, in the solution, due to reasons such as out-of-date ephemeris information, a deviation in precision of the ephemeris, or a delay jitter in signal processing, ephemeris information obtained by a terminal device is usually inaccurate, or when it is difficult for a terminal device to obtain and utilize complete and effective ephemeris information, there is an error in a determined TA and a determined frequency offset. If the TA error exceeds a length of a cyclic prefix CP of a PRACH sequence, the PRACH sequence likely falls outside a detection window of a satellite. As a result, random access performed by the terminal device fails, and it cannot be ensured that the terminal device implements uplink synchronization with the satellite.

In conclusion, a timing advance determining method is urgently needed, to accurately determine a timing advance between a terminal device and a satellite, so as to ensure that the terminal device implements uplink synchronization with the satellite.

Therefore, this application provides a timing advance determining method. The method includes: First, a first communication apparatus obtains first information about a reference time signal, where the reference time signal is a periodic signal; then, the first communication apparatus determines, based on the first information, a reference moment at which the reference time signal is generated; and finally, the first communication apparatus determines a timing advance based on the reference moment and a first moment at which the first communication apparatus receives a downlink signal. According to the method, the first communication apparatus determines, based on the first information, the reference moment at which the reference time signal is generated. Because the reference time signal is periodic, the first communication apparatus can accurately calculate a timing advance based on reference moments in different periodicities and moments at which downlink signals are received, ensuring that the first communication apparatus implements uplink synchronization.

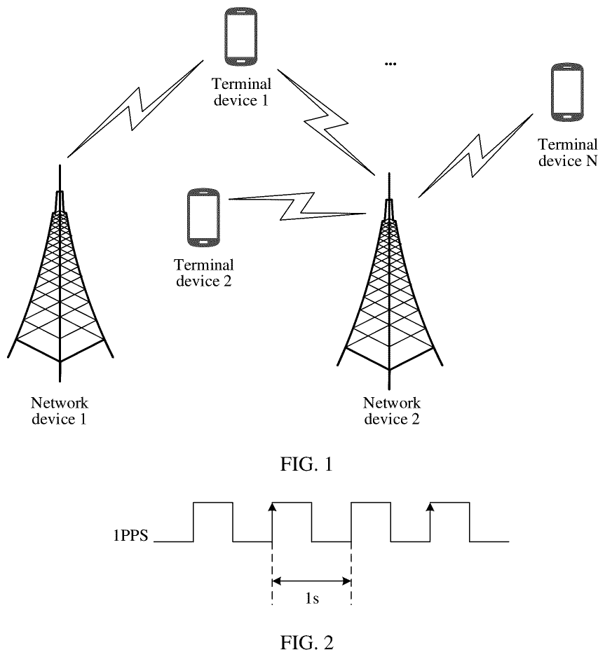

To facilitate understanding of the technical solutions in embodiments of this application, the following shows, with reference to FIG. 1, a possible communication system to which a beam use method provided in an embodiment of this application is applicable.

FIG. 1 is a diagram of a wireless communication system according to an embodiment of this application. As shown in FIG. 1, the wireless communication system includes at least one terminal device and at least one network device. A network device may provide services to one or more terminal devices. For example, a network device 1 provides services to a terminal device 1, and a network device 2 may provide communication services to the terminal device 1, a terminal device 2, . . . , and a terminal device N separately. In addition, a terminal device may be alternatively served by different network devices. For example, the terminal device 1 may be served by the network device 1, or may be served by the network device 2. In addition, geographical locations of the at least one terminal device and the at least one network device are not specifically limited in this application.

The solutions in this application may be used in wireless communication systems such as 5G and satellite communication. The wireless communication systems include but are not limited to: 4th generation (4G) communication systems such as narrow band-internet of things (NB-IoT) systems and long term evolution (LTE) systems, 5th generation (5G) communication systems such as new radio (NR) systems, post-5G evolved communication systems such as 6th generation (6G) communication systems, and communication systems that support convergence of a plurality of radio technologies, for example, a system that integrates an NTN system such as an uncrewed aerial vehicle, a satellite communication system, or high altitude platform station (HAPS) communication with terrestrial wireless communication such as 5G.

A communication system to which this application is applicable includes a first communication apparatus and a second communication apparatus. The first communication apparatus may serve as a sending end or receiving end, and the second communication apparatus may also serve as a sending end. The first communication apparatus may be a network device or terminal device, and the second communication apparatus may be a network device or terminal device. When serving as a sending end, the first communication apparatus may be a network device, and in this case, the second communication apparatus serves as a receiving end and may be a terminal device; or when serving as a sending end, the first communication apparatus may be a terminal device, and in this case, the second communication apparatus serves as a receiving end and may be a network device. Alternatively, when serving as a sending end, the first communication apparatus may be a terminal device, and in this case, the second communication apparatus serves as a receiving end and may be a terminal device. This is not limited in this application.

The following describes a terminal device and a network device in this application.

A terminal device may be a wireless terminal device that can receive information scheduled and indicated by a network device. A terminal device may be a device that provides a user with voice and/or data connectivity, a handheld device that has a wireless connectivity function, or another processing device connected to a wireless modem.

A terminal device is also referred to as user equipment (UE), a mobile station (mobile station, MS), a mobile terminal (MT), or the like. A terminal device is a device that includes a wireless communication function (providing a user with voice/data connectivity). Currently, some examples of a terminal device are as follows: a mobile phone (mobile phone), a tablet computer, a notebook computer, a palmtop computer, a satellite terminal, a mobile internet device (MID), a point of sale (point of sale, POS) device, a wearable device, a virtual reality (VR) device, an augmented reality (AR) device, a wireless terminal in industrial control (industrial control), a wireless terminal in an internet of vehicles, a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. For example, a wireless terminal in the internet of vehicles may be a vehicle-mounted device, an entire vehicle device, a vehicle-mounted module, a vehicle, or the like. A wireless terminal in industrial control may be a camera, a robot, or the like. A wireless terminal in a smart home may be a television, an air conditioner, a sweeper, a speaker, a set-top box, or the like.

A terminal device may be widely used in various scenarios, for example, device-to-device (D2D) communication, vehicle to everything (V2X) communication, machine-type communication (MTC), an internet of things (IoT), telemedicine, smart furniture, smart offices, smart wearables, and smart transportation.

In this embodiment of this application, an apparatus configured to implement functions of a terminal device may be a terminal device, or may be an apparatus that can support a terminal device to implement the function, for example, a chip system. The apparatus may be installed in or used in conjunction with a terminal device. In this embodiment of this application, the chip system may include a chip, or may include a chip and another discrete component.

A network device may be a device in a wireless network. For example, a network device may be a device that is deployed in a radio access network to provide a wireless communication function for terminal devices. For example, a network device may be a radio access network (RAN) node that connects a terminal device to a wireless network, and may also be referred to as an access network device or a base station.

A network device includes but is not limited to an evolved NodeB (eNB), a radio network controller (RNC), a home NodeB (for example, a home evolved NodeB, or a home NodeB, HNB), a baseband unit (BBU), a radio relay node, a radio backhaul node, a transmission point (TP), or the like. Alternatively, a network device may be a network device in a 5G mobile communication system, for example, a next generation NodeB (gNB), a transmission reception point (TRP), or a TP in an NR system, or an antenna panel or a group of antenna panels (including a plurality of antenna panels) in a 5G mobile communication system. Alternatively, a network device may be a network node that constitutes a gNB or a transmission point, such as a BBU or a distributed unit (DU). Alternatively, a network device may be a terminal device providing a base station function in V2X communication, M2M communication, or D2D communication, or the like.

A base station is an apparatus that is deployed in a radio access network to provide a wireless communication function for terminal devices. The base station may include a macro base station, a micro base station (also referred to as a small cell), a relay station, an access point, and the like in various forms. In systems using different radio access technologies, names of devices with the base station function may be different. In addition, the base station may alternatively be a satellite. For ease of description, in all embodiments of this application, the foregoing apparatuses that provide the wireless communication function for terminal devices are collectively referred to as network devices.

In this embodiment of this application, an apparatus configured to implement functions of a network device may be a network device, or may be an apparatus that can support a network device to implement the function, for example, a chip system. The apparatus may be installed in or used in conjunction with a network device. In this embodiment of this application, the chip system may include a chip, or may include a chip and another discrete component.

In some embodiments, a terminal device and a network device may communicate by using an air interface (Uu) link, a communication link of a non-terrestrial network NTN, or the like between the terminal device and the network device. Terminal devices may communicate by using sidelinks (sidelink, SL) such as D2D. Specifically, a terminal device may be in a connected state or an active (active) state, or may be in a non-connected state (inactive) or an idle (idle) state, or may be in another state, for example, a state in which the terminal device is not attached to a network or downlink synchronization with a network is not performed.

Communication may be performed between a network device and a terminal device, between network devices, and between terminal devices by using a licensed spectrum, or may be performed by using an unlicensed spectrum, or may be performed by using both a licensed spectrum and an unlicensed spectrum. Communication may be performed by using a spectrum below 6 gigahertz (GHz), for example, by using a 700/900 megahertz (MHz) or a 2.1/2.6/3.5 GHz frequency band, or may be performed by using a spectrum above 6 GHz, for example, by using a millimeter wave or a terahertz (THz) wave, or may be performed by using both a spectrum below 6 GHz and a spectrum above 6 GHz. Spectrum resources used for wireless communication are not specifically limited in embodiments of this application.

To facilitate understanding of the technical solutions in this application, the following describes some technical terms used in this application.

### (1) Timing Advance TA

An important characteristic of uplink transmission is that different terminal devices perform orthogonal multiple access (OMA) in time and frequencies. To be specific, uplink transmissions of different Ues in a same cell do not interfere with each other. To ensure orthogonality of uplink transmission and avoid intra-cell (intra-cell) interference, a network device requires that signals from different terminal devices and from a same subframe but different frequency-domain resources, that is, different resource blocks (RB), arrive at the network device at basically aligned moments. The network device can correctly decode uplink data sent by a terminal device, provided that the network device receives the uplink data within a range of a cyclic prefix CP. Therefore, uplink synchronization requires that moments at which signals from different terminal devices and from a same subframe arrive at the network device all fall within the CP.

To ensure time synchronization on a reception side (a network device side), an uplink timing advance (UTA) mechanism is proposed.

From a perspective of a terminal device side, a timing advance is essentially a negative offset (negative offset) between a starting moment at which a downlink subframe is received and a moment at which an uplink subframe is transmitted. By properly controlling an offset for each terminal device, the network device can control moments at which uplink signals from different terminal devices arrive at the network device. In addition, due to a long transmission delay, a terminal device far away from the network device sends uplink data earlier than a terminal device close to the network device.

(2) 1 Pulse Per Second (pps) Signal

As shown in FIG. 2, a 1 pps signal is a square wave signal at a frequency of 1 Hz. Regardless of a location of a module that generates 1 pps signals, for example, a global navigation satellite system (GNSS) module, edges of 1 pps pulses output by the module are strictly aligned. Therefore, 1 pps pulse signals output by GNSS modules in devices in various geographical locations (for example, a satellite and a terminal device) are synchronized with each other.

For an enhanced timing synchronization procedure based on 1 pps assistance, refer to FIG. 2. For example, in a satellite communication system, when a known maximum transmission delay does not exceed 10 ms, a maximum transmission distance of 3000 km can be covered.

### (3) Reference Time Signal

Communication apparatuses located in different geographical locations (for example, a network device and a terminal device) may separately generate, based on 1 pulse per second timing described above, reference time signals required by air interface frames, for example, reference time signals at intervals of 10 ms. Arising edge of a signal at an exact second is aligned with a rising edge of GNSS 1 pps.

Therefore, 1 pulse per second signals generated by communication apparatuses located in different geographical locations are synchronized with each other, and reference time signals generated by the devices in different geographical locations are also synchronized with each other. In this case, reference moments at which the reference time signals are generated and that are determined by the communication devices located in different geographical locations are also synchronized with each other. In addition, because the reference time signal is a periodic signal, different communication apparatuses or modules can generate the reference time signal periodically.

(4) “a plurality of” in embodiments of this application means “two or more”. “and/or” describes an association relationship between associated objects, and indicates that three relationships may exist. For example, A and/or B may indicate the following three cases: Only A exists, both A and B exist, and only B exists. The character “/” usually indicates an “or” relationship between associated objects. In addition, it should be understood that in descriptions of this application, terms such as “first” and “second” are used for distinguishing purposes only, and shall not be understood as indicating or implying relative importance, or indicating or implying a sequence.
(5) The terms “including”, “having”, and any variant thereof mentioned in descriptions of embodiments of this application are intended to cover a non-exclusive inclusion. For example, a process, method, system, product, or device that includes a series of steps or units is not limited to listed steps or units, but optionally further includes another unlisted step or unit, or optionally further includes another step or unit inherent in the process, method, product, or device. It should be noted that in embodiments of this application, the word such as “example” or “for example” is used to represent giving an example, an illustration, or a description. Any embodiment or design scheme described as an “example” or “for example” in embodiments of this application should not be explained as being more preferred or having more advantages than another embodiment or design scheme. Exactly, use of the word “example”, “for example”, or the like is intended to present a related concept in a specific manner.
(6) The term “indicating” mentioned in descriptions of embodiments of this application may include directly indicating and indirectly indicating. When a piece of indication information indicates A, the indication information may directly indicate A or indirectly indicate A, but it does not indicate that the indication information definitely carries A.

Information indicated by indication information is referred to as to-be-indicated information. In a specific implementation process, there are a plurality of manners of indicating the to-be-indicated information, for example, but not limited to, the following manners: The to-be-indicated information is directly indicated, for example, the to-be-indicated information or an index of the to-be-indicated information; or the to-be-indicated information may be indirectly indicated by indicating other information, where there is an association relationship between the other information and the to-be-indicated information; or only a part of the to-be-indicated information may be indicated, where the other part of the to-be-indicated information is known or agreed upon in advance. The to-be-indicated information may be sent as a whole, or may be divided into a plurality of pieces of sub-information and sent separately. In addition, sending periodicities and/or sending moments of these pieces of sub-information may be the same or different. A specific sending method is not limited in this application.

The following describes the technical solutions in this application with reference to specific embodiments.

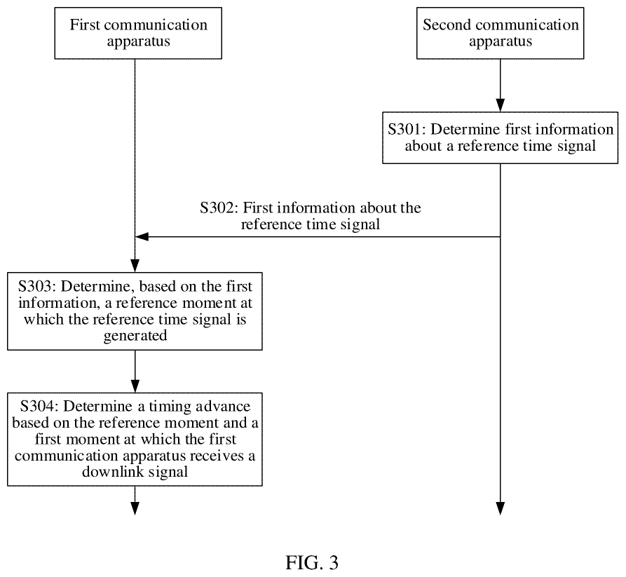

FIG. 3 is a schematic flowchart of a timing advance determining method according to an embodiment of this application. The method may be performed by a transceiver and/or processor in a first communication apparatus (which may alternatively be a second communication apparatus), or may be performed by a chip corresponding to the transceiver and/or processor. Alternatively, this embodiment may be implemented by a controller or control device connected to the first communication apparatus (which may alternatively be the second communication apparatus). The controller or control device is configured to manage at least one device including the first communication apparatus (which may alternatively be the second communication apparatus). In addition, a specific form of a communication apparatus performing the embodiment is not specifically limited in this application. With reference to FIG. 3, a specific process of the method is as follows.

S301: A second communication apparatus determines first information about a reference time signal.

Optionally, the second communication apparatus may be a network device, for example, a satellite or a base station.

The reference time signal is a periodic signal, and the first information is used for determining a reference moment at which the reference time signal is generated.

In an implementation, that a second communication apparatus determines first information about a reference time signal includes: The second communication apparatus determines a periodicity of the reference time signal based on positional information between the second communication apparatus and a first communication apparatus and a first mapping, where the first mapping is a correspondence between the positional information and the periodicity of the reference time signal.

Optionally, the first mapping may be information agreed upon by or information stored in advance by the first communication apparatus and the second communication apparatus.

The positional information may include but is not limited to: a difference between heights of the first communication apparatus and the second communication apparatus, a direction angle at which or a beam direction in which the first communication apparatus and the second communication apparatus communicate, and geographical coordinates of the first communication apparatus and the second communication apparatus.

In this embodiment of this application, the periodicity of the reference time signal may be alternatively expressed as a time interval between two adjacent reference time signals that are generated.

S302: The second communication apparatus sends the first information about the reference time signal.

Correspondingly, the first communication apparatus obtains the first information about the reference time signal. The first communication apparatus may obtain the first information about the reference time signal in a direct manner. For example, the first communication apparatus directly receives the first information from the second communication apparatus. Alternatively, the first communication apparatus may obtain the first information about the reference time signal in an indirect manner. For example, the first communication apparatus obtains signal information from the second communication apparatus, where the signal information includes the first information about the reference time signal; or a third communication apparatus first obtains the first information about the reference time signal from the second communication apparatus, and the first communication apparatus then receives the first information from the third communication apparatus. Therefore, a manner in which the first communication apparatus obtains the first information about the reference time signal is not specifically limited in this application.

The first information includes the periodicity of the reference time signal; or the first information includes a first index, and the first index indicates the periodicity of the reference time signal.

Optionally, the first information may be alternatively agreed upon by the first communication apparatus and the second communication apparatus. In this case, step S302 may not be performed.

Optionally, the first communication apparatus may be a terminal device.

It should be noted that after the second communication apparatus sends the first information, a receiving end receiving the first information may not be limited to the first communication apparatus, and may alternatively be other communication apparatuses. When communicating with the second communication apparatus through a random access procedure, all these communication apparatuses may perform steps performed by the first communication apparatus, to implement uplink synchronization with the second communication apparatus. In this embodiment of this application, an example is used for detailed description in which the first communication apparatus serves as a receiving end.

Optionally, the first information may be broadcast information. In an implementation, the periodicity of the reference time signal is greater than or equal to a first delay; and the first delay is a transmission delay between the first communication apparatus and the second communication apparatus, or the first delay is a difference between a maximum value and a minimum value of a transmission delay between the first communication apparatus and the second communication apparatus.

In an implementation, the periodicity of the reference time signal meets that a value of Num_SFN/(ΔT₁ₚₚₛ/L_SFN) is an integer, where ΔT₁ₚₚₛ, represents the periodicity of the reference time signal, Num_SFN represents a quantity of system frames in one frame cycle, and L_SFN represents duration of the system frame. Optionally, in this case, the second communication apparatus sends second information. Correspondingly, the first communication apparatus receives the second information. The second information indicates the quantity of system frames in the one frame cycle. Optionally, the quantity of system frames in the one frame cycle may be predefined, or may be pre-configured in a system.

In some embodiments, the first information sent by the second communication apparatus further includes a first field, and the first field indicates an interval between a starting moment of an air interface frame in a frame cycle and the reference moment; or an interval between a starting moment of an air interface frame in a frame cycle and the reference moment is predefined. Optionally, the interval between the starting moment of the air interface frame in the frame cycle and the reference moment may be alternatively agreed upon by two communication apparatuses (for example, the first communication apparatus and the second communication apparatus), or may be predefined in a standard. A value of the interval between the starting moment of the air interface frame and the reference moment is greater than or equal to 0 and less than or equal to the periodicity of the reference time signal. Optionally, the implementation is applicable to a case in which the periodicity of the reference time signal does not meet that the value of Num_SFN/(ΔT₁ₚₚₛ/L_SFN) is an integer.

Duration of different frame cycles may be the same or different. For example, a frame cycle is 10 ms, 20 ms, 40 ms, 80 ms, or the like. In addition, in each frame cycle, not every system frame is used for sending a downlink signal, and a system frame used for sending a downlink signal may be referred to as an air interface frame.

In an implementation, the periodicity of the reference time signal meets that a value of 1 s/ΔT₁ₚₚₛ is an integer, where ΔT₁ₚₚₛ represents the periodicity of the reference time signal.

It should be noted that ΔT₁ₚₚₛ needs to use a same time unit as Is. For example, if ΔT₁ₚₚₛ is 8 ms, that is, 0.008 s, 1 s/ΔT₁ₚₚₛ=1 s/0.008 s, or 1 s/ΔT₁ₚₚₛ=1000 ms/8 ms.

In an implementation, the second communication apparatus sends third information, where the third information indicates information about an interval between the reference time signal and a 1 pulse per second signal, and the reference time signal is generated based on the 1 pulse per second signal. Correspondingly, the first communication apparatus receives the third information from the second communication apparatus. Optionally, the implementation is applicable to a case in which the periodicity ΔT₁ₚₚₛ of the reference time signal does not meet that the value of 1 s/ΔT₁ₚₚₛ is an integer.

Optionally, the information about the interval between the reference time signal and the 1 pulse per second signal may be an interval between the reference moment and a starting moment of a closest preceding 1 pulse per second signal, or an interval between the reference moment and an ending moment of a closest succeeding 1 pulse per second signal.

In some embodiments, the third information may also indicate information related to the interval between the reference time signal and the 1 pulse per second signal. For example, the information related to the interval includes compression of the interval. The compression may be:

$$interval - ⌊ \frac{interval}{Δ {T}_{1 pps}} ⌋ \times Δ {T}_{1 pps} .$$

Therefore, the first communication apparatus can indirectly obtain a value of the interval based on the compression of the interval, alternatively.

In an implementation, the second communication apparatus further sends fourth information, where the fourth information indicates a frame structure, and the frame structure is used for determining an interval between a starting moment of an air interface frame in a frame cycle and a sending moment of a downlink signal. Correspondingly, the first communication apparatus receives the fourth information from the second communication apparatus.

Usually, before sending a downlink signal, the second communication apparatus already determines configuration information of a frame structure. The configuration information indicates frames that are in a frame cycle and that are used for sending a downlink signal or data. Therefore, after receiving the fourth information sent by the second communication apparatus, the first communication apparatus can learn of the frame structure, that is, can determine an interval between a starting position of a frame in a frame cycle and a sending position of a downlink signal. Because the frame may be an air interface frame, it is equivalent to determining an interval between a starting moment of the air interface frame in the frame cycle and the sending moment of the downlink signal.

In an implementation, the first information may further include second indication information. The second indication information indicates a validity period for the periodicity of the reference time signal, for example, indicates a period of time after which the periodicity of the reference time signal should be updated. Alternatively, the second communication apparatus sends fifth information to the first communication apparatus. The fifth information indicates a validity period for the periodicity of the reference time signal.

S303: The first communication apparatus determines, based on the first information, a reference moment at which the reference time signal is generated.

In an implementation, the reference time signal is generated based on a 1 pulse per second signal. For example, the reference time signal is generated based on a GNSS 1 pps signal.

Optionally, the second communication apparatus sends first indication information, where the first indication information indicates information about a module that generates the 1 pulse per second signal. Correspondingly, the first communication apparatus receives the first indication information from the second communication apparatus.

For example, when the first communication apparatus (for example, a terminal device) and the second communication apparatus (for example, a satellite) have a plurality of modules that can provide 1 pps signals, for example, global positioning system (GPS) and BeiDou, the second communication apparatus (for example, a satellite) may further send first indication information to the first communication apparatus (for example, a terminal device). The first indication information indicates information about a module that generates a 1 pps signal. For example, one bit is used for indication. When the bit is 0, it indicates that a 1 pps signal provided by the GPS module is used for generation of a reference time signal, and when the bit is 0, it indicates that a 1 pps signal provided by the BeiDou module is used for generation of a reference time signal.

S304: The first communication apparatus determines a timing advance based on the reference moment and a first moment at which the first communication apparatus receives the downlink signal.

After the first communication apparatus and the second communication apparatus separately determine the reference moment at which the reference time signal is generated, the second communication apparatus sends the downlink signal. Correspondingly, the first communication apparatus receives the downlink signal. The downlink signal may be a synchronization signal and physical broadcast channel (PBCH) block (SSB), a primary synchronization signal (PSS), or the like. In this case, the first communication apparatus may determine the timing advance based on the first moment at which the downlink signal is received and the reference moment determined by the first communication apparatus.

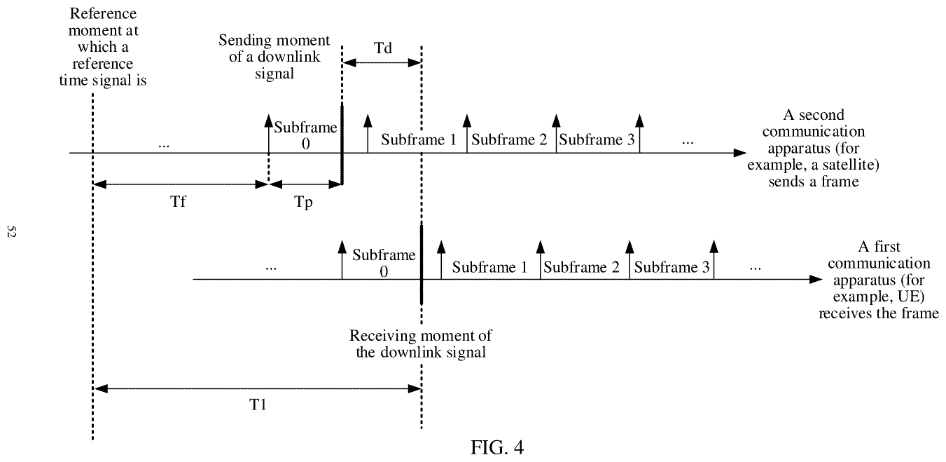

In an implementation, as shown in FIG. 4, Td represents a transmission delay between a first communication apparatus and a second communication apparatus, T1 is an interval between a reference moment and a first moment at which the first communication apparatus receives a downlink signal, Tf is an interval between a starting moment of an air interface frame in a frame cycle and the reference moment, and Tp is an interval between the starting moment of the air interface frame in the frame cycle and a sending moment of the downlink signal. TA is a timing advance. The timing advance TA satisfies the following formulas:

$$Td = T 1 - T f - Tp , and$$

$$TA = 2 \times Td ,$$

where Td, T1, Tf, Tp, and TA are all values greater than or equal to 0, and x is a multiplication sign.

Because the GNSS 1 pps signal is stable for a long term, the reference time signal generated based on the GNSS 1 pps signal is also stable for a long term. Therefore, it can be ensured that the obtained TA is accurate, and further it can be ensured that when the first communication apparatus (for example, a terminal device) sends an uplink signal to the second communication apparatus (for example, a satellite), the uplink signal is precisely synchronized with a detection window of the second communication apparatus.

In conclusion, this application provides a timing advance determining method. The method includes: First, a first communication apparatus obtains first information about a reference time signal, where the reference time signal is a periodic signal; then, the first communication apparatus determines, based on the first information, a reference moment at which the reference time signal is generated; and finally, the first communication apparatus determines a timing advance based on the reference moment and a first moment at which the first communication apparatus receives a downlink signal. According to the method, the first communication apparatus determines, based on the first information, the reference moment at which the reference time signal is generated. Because the reference time signal is periodic, the first communication apparatus can accurately calculate a timing advance based on reference moments in different periodicities and moments at which downlink signals are received, ensuring that the first communication apparatus implements uplink synchronization.

The following further describes, in detail by using several specific implementations, the timing advance determining method provided in the solutions in this application.

### Implementation 1

In the implementation 1, rules for generating a reference time signal and solutions to determining a timing advance under different rules are provided. For example, a first communication apparatus is a satellite, a second communication apparatus is a terminal device (UE), and a periodicity of the reference time signal (an interval between two adjacent reference time signals that are generated based on GNSS 1 pps) is ΔT₁ₚₚₛ. ΔT₁ₚₚₛ needs to meet the following rules.

Rule 1: ΔT₁ₚₚₛ≥ΔT_{delay},
where ΔT_{delay} is a transmission delay between the satellite and the UE. A value of the transmission delay may depend on factors such as an orbital altitude of the satellite and a communication elevation angle between the satellite and the UE.

When the transmission delay ΔT_{delay} is greater than ΔT₁ₚₚₛ, ΔT_{delay} spans a plurality of reference time signal periodicities. In this case, the transmission delay may not be accurately determined, and finally a timing advance cannot be accurately determined either. According to the rule 1, the following can be ensured: After receiving a downlink signal (for example, an SSB) sent by the satellite, the UE only needs to calculate an interval between a moment at which the UE receives the downlink signal and a reference moment at which an associated reference time signal is generated, and then further determines a transmission delay according to the formula in step S304. This avoids that the transmission delay ΔT_{delay} is greater than ΔT₁ₚₚₛ, and ensures that the timing advance is accurate.

Rule 2: Num_SFN/(ΔT₁ₚₚₛ/L_SFN) is an integer.

For example, when Num_SFN=1024, it indicates that there are 1024 system frames (indexes of the system frames are 0 to 1023), and when L_SFN=10 ms, it indicates that duration of one system frame is 10 ms.

According to the rule 2, it can be ensured that intervals between boundaries of system frames with a same index and associated reference time signals are the same in different cycles of 1024 system frames sent by the satellite.

Rule 3: 1 s/ΔT₁ₚₚₛ is an integer.

According to the rule 3, it can be ensured that reference time signals generated by the satellite and the UE based on GNSS 1 pps can be aligned.

For example, when ΔT₁ₚₚₛ=10 ms, because the transmission delay ΔT_{delay} between the UE and the satellite should meet the rule 1, that is, ΔT₁ₚₚₛ≥ΔT_{delay}, a maximum value of ΔT_{delay} should be 10 ms. If signals between the UE and the satellite are transmitted at a speed of 300000 km/s, a range with a maximum transmission distance between the UE and the satellite of 3000 km can be supported. For another example, when ΔT₁ₚₚₛ=40 ms, if signals between the UE and the satellite are transmitted at a speed of 300000 km/s, a range with a maximum transmission distance between the UE and the satellite of 12000 km can be supported. The range can basically meet requirements of low earth orbit satellites. In other words, when ΔT₁ₚₚₛ=40 ms, 40 ms may be a maximum value that meets all the foregoing rules.

Therefore, the satellite may determine ΔT₁ₚₚₛ according to the foregoing rules and indicate ΔT₁ₚₚₛ to the UE.

When the UE determines the timing advance based on the transmission delay according to the formula in step S304, the UE further needs to determine values of Tf and Tp. Tp is usually determined based on a frame structure and is a known value. The value of Tp may be indicated to the UE by the satellite, or the value of Tp is agreed upon by the satellite and the UE. The UE may specifically obtain the value of Tf by using the following possible solutions.

Solution 1: The value of Tf is agreed upon in a standard.

In the solution 1, the value of Tf is agreed upon in the standard, and an interval between a starting position of a system frame with SFNmod(ΔT₁ₚₚₛ/10 ms)=0 and an associated reference time signal is Tf, where SFN is a system frame number (SFN). The value of Tf is greater than or equal to 0 and less than or equal to the periodicity ΔT₁ₚₚₛ of the reference time signal.

When Tf=0, a calculation process of determining the timing advance can be shortened, reducing system overheads.

Solution 2: The satellite indicates the value of Tf to the UE by using signaling.

For example, a first field is added to first information that is sent to the UE by the satellite. The first field indicates the value of Tf.

Optionally, the first information may be a downlink broadcast signal.

In the implementation 1, the satellite may design the periodicity of the reference time signal according to the foregoing rules and indicate corresponding information to the UE. Therefore, when a transmission distance between the UE and the satellite is in a more complex case, the design can assist the UE to accurately calculate the timing advance.

### Implementation 2

Regarding how a periodicity of a reference time signal, that is, a time interval ΔT₁ₚₚₛ between two adjacent reference time signals, meets the design rules in the implementation 1, the following different cases are included.

In a first case, the periodicity of the reference time signal meets the rule 1 and the rule 2 but does not meet the rule 3.

For example, when it is determined based on a range of a transmission delay between UE and a satellite that ΔT₁ₚₚₛ=80 ms, 1 s/ΔT₁ₚₚₛ is not an integer, that is, a quantity of 80-ms reference time signal periodicities included in one second is not exactly an integer. In this case, intervals between adjacent 1 pps signals and reference time signals that are closest to the adjacent 1 pps signals are different, likely resulting in an inconsistency between reference time signals at intervals of 80 ms that are separately generated by the satellite and the UE based on 1 pps. For example, the satellite generates reference time signals at intervals of 80 ms from a moment T, whereas the UE generates reference time signals at intervals of 80 ms from a moment T+1(s). As a result, the reference time signals generated by the satellite and the UE are not aligned, and consequently there is a deviation in a finally determined transmission delay.

For the problem caused in the first case, the satellite may send first indication information to the UE. The indication information indicates, to the UE, a relative positional relationship between a reference time signal associated with the satellite and a 1 pps signal.

Optionally, the satellite may add indication information to a downlink broadcast signal. The indication information indicates, to the UE, a relative positional relationship between a reference time signal associated with the satellite and a 1 pps signal.

For example, the indication information may also indicate an interval between an associated reference time signal and a 1 pps signal, for example, an interval between the associated reference time signal and a closest preceding 1 pps signal or an interval between the associated reference time signal and a closest succeeding 1 pps signal. Alternatively, the indication information indicates information related to the interval between the associated reference time signal and the 1 pps signal. For example, the information related to the interval includes compression of the interval. The compression may be:

$$interval - ⌊ \frac{interval}{Δ {T}_{1 pps}} ⌋ \times Δ {T}_{1 pps} .$$

In this case, the UE can indirectly calculate a value of the interval based on the compression information of the interval. Therefore, in this manner, it can be ensured that the reference time signals generated by the UE are consistent with the reference time signals generated by the satellite.

For example, because 2 s/80 ms is an integer, that is, a quantity of 80-ms reference time signal periodicities included in two seconds is exactly an integer, reference time signals generated by a satellite and UE based on two 1 pps signals are aligned. In this case, the satellite may send 1-bit indication information to the UE. The 1-bit indication information indicates whether an associated reference time signal is located in a 0^{th} second to a 1^{st} second (corresponding to a first 1 pps) or in a 1^{st} second to a 2^{nd} second (corresponding to a second 1 pps) in the two seconds. In this way, it can be ensured that the UE accurately determines a reference moment and finally can accurately determine a timing advance.

In a second case, the periodicity of the reference time signal meets the rule 1 and the rule 3 but does not meet the rule 2.

An example of that Num_SFN/(ΔT₁ₚₚₛ/L_SFN) is not an integer is as follows: ΔT₁ₚₚₛ=50 ms, Num_SFN=1024, and L_SFN=10 ms. In the second case, in different cycles of system frames (each frame cycle includes 1024 frames) sent by a satellite, intervals Tf between starting positions of system frames corresponding to a same frame number and associated reference time signals change. As a result, UE may not be able to obtain an accurate value of Tf.

For example, the problem caused in the second case can be resolved by using the following solutions.

Solution 1: A first field is added to first information that is sent to the UE by the satellite. The first field indicates the value of Tf or information related to Tf.

Optionally, the first information may be a broadcast signal.

It should be understood that the information related to Tf is information that can be used for calculating the value of Tf, for example, an expression variant of the value of Tf.

Solution 2: A total quantity of system frames in one frame cycle may be limited. A total post-limitation quantity of system frames in one frame cycle may be represented by Num_SFNₗᵢₘᵢₜ. In this case, system frame numbers are 0 to Num_SFNₗᵢₘᵢₜ−1, and it is required that Num_SFNₗᵢₘᵢₜ meets that Num_SFNₗᵢₘᵢₜ/(ΔT₁ₚₚₛ/L_SFN) is an integer, where ΔT₁ₚₚₛ represents a periodicity of a reference time signal, and L_SFN represents duration of one system frame.

Optionally, Num_SFNₗᵢₘᵢₜ is let satisfy the following formula: Num_SFNₗᵢₘᵢₜ=└Num_SFN/(ΔT₁ₚₚₛ/L_SFN)┘·(ΔT₁ₚₚₛ/L_SFN), where ΔT₁ₚₚₛ is a periodicity of a reference time signal, Num_SFN is a total quantity of system frames in one frame cycle, a value of Num_SFN is predefined, or is pre-configured in a system, and a sign └ ┘ represents rounding up, which can ensure that a total post-limitation quantity Num_SFNₗᵢₘᵢₜ of system frames in one frame cycle meets that Num_SFNₗᵢₘᵢₜ/(ΔT₁ₚₚₛ/L_SFN) is an integer.

In this case, the satellite may indicate a post-limitation maximum system frame number in one frame cycle to the UE. Alternatively, the satellite indicates a total quantity of system frames in one frame cycle to the UE, and the UE may also perform calculation according to the foregoing formula and obtain a post-limitation range of system frame numbers in one frame cycle.

In a third case, the periodicity of the reference time signal meets the rule 1 but does not meet the rule 2 and the rule 3.

For example, when ΔT₁ₚₚₛ=30 ms, refer to the solutions in the first case and the second case. Details are not described herein again.

In the implementation 2, the problems existing in the cases in which the periodicity of the reference time signal (the time interval ΔT₁ₚₚₛ between two adjacent reference time signals) meets different rules can be resolved flexibly and effectively. Therefore, it can be ensured that a timing advance determined by the UE by using the method provided in this application is accurate.

### Implementation 3

In the implementation 3, a further description is mainly provided for how the second communication apparatus determines the periodicity of the reference time signal based on the positional information between the second communication apparatus and the first communication apparatus and according to the first mapping in S301 in the foregoing embodiment. The periodicity of the reference time signal is a time interval ΔT₁ₚₚₛ between two adjacent reference time signals that are generated. Specifically, the following may be included.

A value range of ΔT₁ₚₚₛ may be designed according to the rule 1 in the implementation 1. A specific value of ΔT₁ₚₚₛ is related to a range of a transmission delay between a satellite and UE. As the satellite moves, the satellite is in different positions in an orbit, resulting in a large change in the transmission delay between the satellite and the UE. Therefore, the satellite may indicate a value of ΔT₁ₚₚₛ to the UE.

For example, in a case in which a satellite is in a low orbit with an orbital altitude of 1000 km, when a communication elevation angle is 90°, a transmission distance between the satellite and UE is about 1000 km, whereas when a communication elevation angle is 10°, a transmission distance between the satellite and UE approaches 6000 km. When the transmission distance between the satellite and the UE is in a range from 1000 km to 3000 km, if a transmission speed between the satellite and the UE is 300000 km/s, a maximum transmission delay is 10 ms, and a periodicity ΔT₁ₚₚₛ=10 ms of a reference time signal can meet the rule 1. In this case, the satellite indicates ΔT₁ₚₚₛ=10 ms to the UE. When the transmission distance between the satellite and the UE is in a range from 3000 km to 6000 km, if a transmission speed between the satellite and the UE is 300000 km/s, a maximum transmission delay is 20 ms, and a periodicity ΔT₁ₚₚₛ=20 ms of a reference time signal can meet the rule 1. In this case, the satellite indicates ΔT₁ₚₚₛ=20 ms to the UE.

For another example, different satellites are in different orbits, with a satellite 1 at an orbital altitude of 500 km and a satellite 2 at an orbital altitude of 1000 km. In this case, the satellite 1 indicates ΔT₁ₚₚₛ¹=10 ms to UE, whereas the satellite 2 indicates ΔT₁ₚₚₛ²=20 ms to UE.

It can be learned based on the foregoing information that a value of ΔT₁ₚₚₛ can be determined based on an orbital altitude h of a satellite, a communication elevation angle θ (beam direction) between the satellite and UE, and the like. With reference to Table 1, a satellite may determine a corresponding value of ΔT₁ₚₚₛ based on an orbital altitude h between the satellite and UE, and a communication elevation angle θ (beam direction) between the satellite and the UE, and indicate the determined value of ΔT₁ₚₚₛ to the UE. Alternatively, when a satellite and UE both know information in Table 1, the satellite only needs to indicate a first index in Table 1 to the UE, and the UE can determine a corresponding value of ΔT₁ₚₚₛ based on the first index and the known Table 1.

TABLE 1

| | | Communication | |
|---|---|---|---|
| First | Orbital | elevation angle θ | |
| index | altitude h | (beam direction) | ΔT₁ₚₚₛ |
| 1 | h₁ ≤ h < h₂ | θ₁ ≤ θ < θ₂ | T₁ |
| 2 | h₃ ≤ h < h₄ | θ₃ ≤ θ < θ₄ | T₂ |
| . . . | . . . | . . . | . . . |

It should be noted that the positional information includes but is not limited to the positional information in Table 1, and may further include geographical coordinates of the satellite and the UE, and the like. In addition, in this embodiment of this application, determining a corresponding value of ΔT₁ₚₚₛ is not limited to determining a corresponding value of ΔT₁ₚₚₛ based on positional information, either. A corresponding value of ΔT₁ₚₚₛ may be alternatively determined based on other information. For example, a satellite and UE may alternatively determine a corresponding value of ΔT₁ₚₚₛ based on identity information and according to mappings between the identity information and values of ΔT₁ₚₚₛ. Therefore, Table 1 is merely an example.

In the implementation 3, the satellite and the UE can flexibly determine the corresponding periodicity of the reference time signal (that is, the time interval ΔT₁ₚₚₛ between two adjacent reference time signals) based on information about geographical locations of the satellite and the UE, ensuring accuracy of ΔT₁ₚₚₛ, and further ensuring accuracy of a timing advance finally determined by the UE.

The following describes communication apparatuses provided in embodiments of this application.

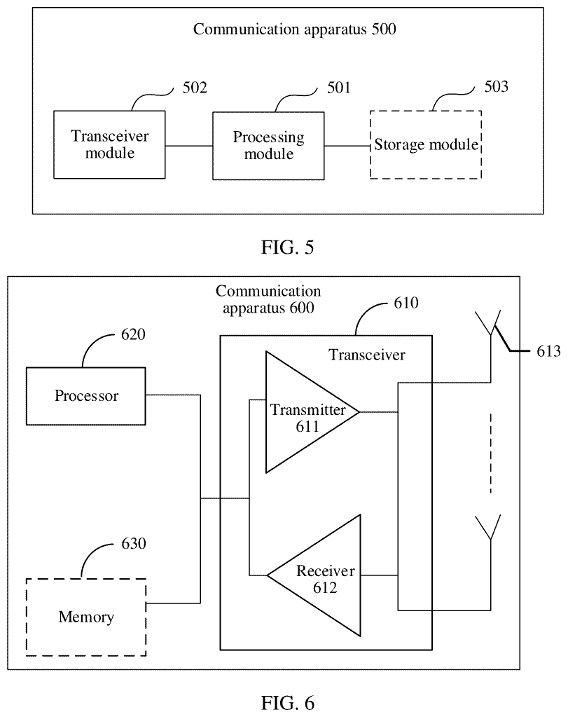

Based on a same technical concept, an embodiment of this application provides a communication apparatus. The communication apparatus may be used in the first communication apparatus in the method in this application, for example, a terminal device. The communication apparatus includes modules or units that one-to-one correspond to the methods/operations/steps/actions performed by the first communication apparatus in the foregoing embodiment. The modules or units may be implemented by hardware circuits, software, or a combination of hardware circuits and software. The communication apparatus has a structure shown in FIG. 5.

As shown in FIG. 5, the communication apparatus 500 may include a processing module 501. The processing module 501 is equivalent to a processing unit, and may be configured to perform a timing advance determining procedure.

Optionally, the communication apparatus 500 further includes a transceiver module 502. The transceiver module 502 may implement corresponding communication functions. Specifically, the transceiver module 502 may specifically include a receiving module and/or a sending module. The receiving module may be configured to receive information, data, and/or like. The sending module may be configured to send information and/or data. The transceiver unit may also be referred to as a communication interface or a transceiver unit.

Optionally, the communication apparatus 500 may further include a storage module 503. The storage module 503 is equivalent to a storage unit, and may be configured to store instructions and/or data. The processing module 501 may read the instructions and/or data in the storage module, so that the communication apparatus implements the foregoing method embodiment.

The communication apparatus 500 may be configured to perform the actions performed by the first communication apparatus in the foregoing method embodiment. The communication apparatus 500 may be the first communication apparatus or a component that can be configured in the first communication apparatus. The transceiver module 502 is configured to perform sending-related operations on a side of the first communication apparatus in the foregoing method embodiment. The processing module 501 is configured to perform processing-related operations on the side of the first communication apparatus in the foregoing method embodiment.

Optionally, the transceiver module 502 may include a sending module and a receiving module. The sending module is configured to perform the sending operations in the foregoing method embodiment. The receiving module is configured to perform the receiving operations in the foregoing method embodiment.

It should be noted that the communication apparatus 500 may include the sending module but does not include the receiving module, or the communication apparatus 500 may include the receiving module but does not include the sending module, specifically depending on whether the foregoing solution performed by the communication apparatus 500 includes sending actions and receiving actions.

For example, the communication apparatus 500 is configured to perform the actions performed by the first communication apparatus in the foregoing embodiment shown in FIG. 3.

For example, the transceiver module 502 is configured to obtain first information about a reference time signal, where the reference time signal is a periodic signal; the processing module 501 is configured to determine, based on the first information, a reference moment at which the reference time signal is generated; and the processing module 501 is further configured to determine a timing advance based on the reference moment and a first moment at which the first communication apparatus receives a downlink signal.

It should be understood that a specific process in which the modules perform the foregoing corresponding procedures is described in detail in the foregoing method embodiment. For brevity, details are not described herein again.

In the foregoing embodiment, the processing module 501 may be implemented by at least one processor or processor-related circuit, the transceiver module 502 may be implemented by a transceiver or transceiver-related circuit, and the storage unit may be implemented by at least one memory.

Based on a same technical concept, an embodiment of this application provides a communication apparatus. The communication apparatus may be used in the second communication apparatus in the method in this application, for example, a network device. The communication apparatus includes modules or units that one-to-one correspond to the methods/operations/steps/actions performed by the second communication apparatus in the foregoing embodiment. The modules or units may be implemented by hardware circuits, software, or a combination of hardware circuits and software. The communication apparatus may also have a structure shown in FIG. 5.

As shown in FIG. 5, the communication apparatus 500 may include a processing module 501. The processing module 501 is equivalent to a processing unit, and may be configured to perform a processing procedure of determining first information about a reference time signal.

Optionally, the communication apparatus 500 further includes a transceiver module 502. The transceiver module 502 may implement corresponding communication functions. Specifically, the transceiver module 502 may specifically include a receiving module and/or a sending module. The receiving module may be configured to receive information, data, and/or like. The sending module may be configured to send information and/or data. The transceiver unit may also be referred to as a communication interface or a transceiver unit.

Optionally, the communication apparatus 500 may further include a storage module 503. The storage module 503 is equivalent to a storage unit, and may be configured to store instructions and/or data. The processing module 501 may read the instructions and/or data in the storage module, so that the communication apparatus implements the foregoing method embodiment.

The communication apparatus 500 may be configured to perform the actions performed by the second communication apparatus in the foregoing method embodiment. The communication apparatus 500 may be the second communication apparatus or a component that can be configured in the second communication apparatus. The transceiver module 502 is configured to perform receiving-related operations on a side of the second communication apparatus in the foregoing method embodiment. The processing module 501 is configured to perform processing-related operations on the side of the second communication apparatus in the foregoing method embodiment.

Optionally, the transceiver module 502 may include a sending module and a receiving module. The sending module is configured to perform the sending operations in the foregoing method embodiment. The receiving module is configured to perform the receiving operations in the foregoing method embodiment.

It should be noted that the communication apparatus 500 may include the sending module but does not include the receiving module, or the communication apparatus 500 may include the receiving module but does not include the sending module, specifically depending on whether the foregoing solution performed by the communication apparatus 500 includes sending actions and receiving actions.

For example, the communication apparatus 500 is configured to perform the actions performed by the second communication apparatus in the foregoing embodiment shown in FIG. 3.

For example, the processing module 501 is configured to determine first information about a reference time signal, where the reference time signal is a periodic signal, and the first information is used for determining a reference moment at which the reference time signal is generated; and the transceiver module 502 is configured to send the first information.

It should be understood that a specific process in which the modules perform the foregoing corresponding procedures is described in detail in the foregoing method embodiment. For brevity, details are not described herein again.

In the foregoing embodiment, the processing module 501 may be implemented by at least one processor or processor-related circuit, the transceiver module 502 may be implemented by a transceiver or transceiver-related circuit, and the storage unit may be implemented by at least one memory.

This application further provides a communication apparatus. The communication apparatus may be a first communication apparatus, a processor in a first communication apparatus, or a chip. The communication apparatus may be configured to perform the operations performed by the first communication apparatus in the foregoing method embodiment. Alternatively, the communication apparatus may be a second communication apparatus, a processor in a second communication apparatus, or a chip. The communication apparatus may be configured to perform the operations performed by the second communication apparatus in the foregoing method embodiment.

FIG. 6 is a simplified diagram of a structure of a communication apparatus. As shown in FIG. 6, the communication apparatus 600 includes a processor 620. Optionally, the communication apparatus 600 further includes a transceiver 610 and a memory 630.

The processor 620 may also be referred to as a processing unit, a processing board, a processing module, a processing apparatus, or the like.

The transceiver 610 may also be referred to as a transceiver module, a transceiver unit, a transceiver, a transceiver circuit, a transceiver apparatus, a communication interface, or the like. Optionally, a component configured to implement a sending function in the transceiver 610 may be considered as a sending unit or sending module, and a component configured to implement a receiving function in the transceiver 610 may be considered as a receiving unit or receiving module. To be specific, the transceiver 610 may include a transmitter 611, a receiver 612, a radio frequency circuit (not shown in the figure), an antenna 613, and an input/output apparatus (not shown in the figure). The transmitter 611 sometimes may also be referred to as a transmitter machine, a transmitting module, a transmitting unit, a transmitting circuit, or the like. The receiver 612 sometimes may also be referred to as a receiver machine, a receiving module, a receiving unit, a receiving circuit, or the like. The radio frequency circuit is mainly configured to perform conversion between a baseband signal and a radio frequency signal and process a radio frequency signal. The antenna 613 is mainly configured to transmit and receive radio frequency signals in a form of electromagnetic waves. The input/output apparatus, for example, a touchscreen, a display screen, or a keyboard, is mainly configured to receive data input by a user and output data to a user. It should be noted that some types of communication apparatuses may not have an input/output apparatus.

The memory 630 is mainly configured to store software programs and data.

When data needs to be sent, the processor 620 performs baseband processing on the data to be sent and then outputs a baseband signal to the radio frequency circuit. The radio frequency circuit performs radio frequency processing on the baseband signal, and then sends out a radio frequency signal by using the antenna in the form of electromagnetic waves. When data is sent to the communication apparatus, the radio frequency circuit receives a radio frequency signal by using the antenna, converts the radio frequency signal into a baseband signal, and outputs the baseband signal to the processor 620. The processor 620 converts the baseband signal into data and processes the data. For ease of description, FIG. 6 shows only one memory, only one processor, and only one transceiver. In an actual communication apparatus product, there may be one or more processors and one or more memories. The memory may also be referred to as a storage medium, a storage device, or the like. The memory may stand alone from the processor, or may be integrated with the processor. This is not limited in this embodiment of this application.

Optionally, the transceiver 610 and the memory 630 may include one or more boards. Each board may include one or more processors and one or more memories. The processor is configured to read and execute a program in the memory to implement a baseband processing function and control of the communication apparatus. If there are a plurality of boards, the boards may be interconnected to enhance processing capabilities. In an optional implementation, a plurality of boards may alternatively share one or more processors, or share one or more memories, or simultaneously share one or more processors.

When the communication apparatus 600 serves as a first communication apparatus, the transceiver 610 is mainly configured to implement a transceiving function of the first communication apparatus. The processor 620 is a control center of the first communication apparatus, and is configured to control the first communication apparatus to perform processing operations on a side of the first communication apparatus in the foregoing method embodiment. The memory 630 is mainly configured to store computer program code and data of the first communication apparatus.

In this embodiment of this application, a transceiver with a transceiving function may be considered as a transceiver module (a transceiver unit) of the first communication apparatus, and a processor with a processing function may be considered as a processing module (a processing unit) of the first communication apparatus.

In an implementation, the processor 620 is configured to perform processing actions on the side of the first communication apparatus in the embodiment shown in FIG. 3, and the transceiver 610 is configured to perform transceiving actions on the side of the first communication apparatus in FIG. 3. For example, the transceiver 610 is configured to perform S302 in the embodiment shown in FIG. 3, which may be specifically obtaining the first information about the reference time signal, where the reference time signal is a periodic signal. The processor 620 is configured to perform a processing operation in S303 in the embodiment shown in FIG. 3, which may be specifically determining, based on the first information, a reference moment at which the reference time signal is generated; and the processor 620 is configured to perform a processing operation in S304 in the embodiment shown in FIG. 3, which may be specifically determining a timing advance based on the reference moment and a first moment at which the first communication apparatus receives a downlink signal.

It should be understood that FIG. 6 is merely an example rather than a limitation, and the first communication apparatus including a transceiver module and a processing module may have a different structure than the structure shown in FIG. 6.

When the communication apparatus serves as a second communication apparatus, the transceiver 610 is mainly configured to implement a transceiving function of the second communication apparatus. The processor 620 is a control center of the second communication apparatus, and is configured to control the second communication apparatus to perform processing operations on a side of the second communication apparatus in the foregoing method embodiment. The memory 630 is mainly configured to store computer program code and data of the second communication apparatus.

In an implementation, the transceiver 610 is configured to perform transceiving-related procedures performed by the second communication apparatus in the embodiment shown in FIG. 3. For example, the transceiver 610 is configured to perform S302 in the embodiment shown in FIG. 3, which may be specifically sending the first information about the reference time signal, where the reference time signal is a periodic signal. The processor 620 is configured to perform processing-related procedures performed by the second communication apparatus in the embodiment shown in FIG. 3. For example, the processor 620 is configured to perform S301 in the embodiment shown in FIG. 3, which may be specifically determining first information about a reference time signal.

It should be understood that FIG. 6 is merely an example rather than a limitation, and the second communication apparatus including a processor, a memory, and a transceiver may have a different structure than the structure shown in FIG. 6.

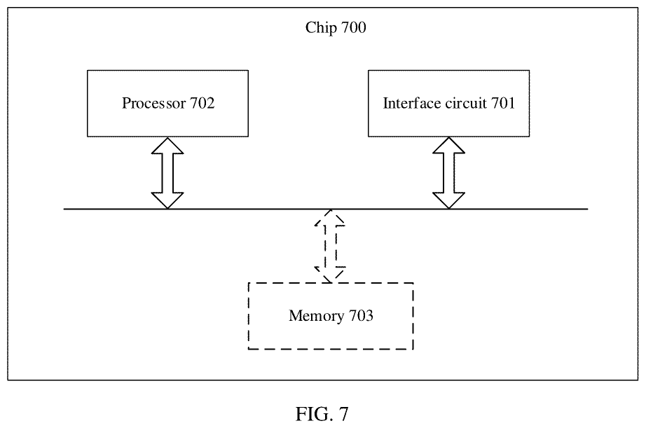

When the first communication apparatus (or the second communication apparatus) is a chip, FIG. 7 is a simplified diagram of a structure of a chip. The chip includes an interface circuit 701 and a processor 702. The interface circuit 701 and the processor 702 are coupled to each other. It may be understood that the interface circuit 701 may be a transceiver or an input/output interface, and the processor may be a processing module, microprocessor, or integrated circuit integrated on the chip. A sending operation performed by the first communication apparatus (or the second communication apparatus) in the foregoing method embodiment may be understood as an output of the chip, and a receiving operation performed by the first communication apparatus (or the second communication apparatus) in the foregoing method embodiment may be understood as an input of the chip.

Optionally, the chip 700 may further include a memory 703, which is configured to store instructions executed by the processor 702, input data required by the processor 702 for running instructions, or data generated after the processor 702 run instructions. Optionally, the memory 703 may alternatively be integrated with the processor 702.

An embodiment of this application further provides a computer-readable storage medium. The computer-readable storage medium stores computer instructions used to implement the method performed by the first communication apparatus or the second communication apparatus in the foregoing method embodiment.

For example, when the computer program is executed by a computer, the computer is enabled to implement the method performed by the first communication apparatus or the second communication apparatus in the foregoing method embodiment.

An embodiment of this application further provides a computer program product including instructions. When the instructions are executed by a computer, the computer is enabled to implement the method performed by the first communication apparatus or the second communication apparatus in the foregoing method embodiment.

An embodiment of this application further provides a communication system. The communication system includes the first communication apparatus and the second communication apparatus in the foregoing embodiments.

An embodiment of this application further provides a chip apparatus, including a processor. The processor is configured to invoke a computer program or computer instructions stored in a memory, so that the processor performs the timing advance determining method in the embodiment shown in FIG. 3.

In some embodiments, an input of the chip apparatus corresponds to a receiving operation in the embodiment shown in FIG. 3, and an output of the chip apparatus corresponds to a sending operation in the embodiment shown in FIG. 3.

Optionally, the processor is coupled to a memory by using an interface.

Optionally, the chip apparatus further includes a memory. The memory stores a computer program or computer instructions.

The processor mentioned anywhere above may be a general-purpose central processing unit, a microprocessor, an application-specific integrated circuit (ASIC), or one or more integrated circuits configured to control execution of a program of the timing advance determining method in the embodiment shown in FIG. 3. The memory mentioned anywhere above may be a read-only memory (ROM), another type of static storage device that can store static information and instructions, a random access memory (RAM), or the like.

It should be noted that for ease and brevity of description, for explanations and beneficial effects of related content of any one of the communication apparatuses provided above, reference may be made to the corresponding method embodiments provided above. Details are not described herein again.

In this application, the first communication apparatus or the second communication apparatus may include a hardware layer, an operating system layer running on the hardware layer, and an application layer running on the operating system layer. The hardware layer may include hardware such as a central processing unit (CPU), a memory management module (MMU), and a memory (also referred to as a main memory). An operating system at the operating system layer may be any one or more computer operating systems that implement service processing by using a process (process), for example, a Linux operating system, a Unix operating system, an Android operating system, an iOS operating system, or a Windows operating system. The application layer may include applications such as a browser, an address book, word processing software, and instant messaging software.

Division into modules in embodiments of this application is an example, is merely division into logical functions, and may be other division during actual implementation. In addition, functional modules in embodiments of this application may be integrated into one processor, or each of the modules may stand alone physically, or two or more modules may be integrated into one module. The integrated module may be implemented in a form of hardware, or may be implemented in a form of a software functional module.

Through descriptions of the foregoing implementations, a person skilled in the art may clearly understand that embodiments of this application may be implemented by hardware, firmware or a combination thereof. When embodiments of this application are implemented by software, the foregoing functions may be stored in a computer-readable medium or transmitted as one or more instructions or code in a computer-readable medium. The computer-readable medium includes a computer storage medium and a communication medium. The communication medium includes any medium that facilitates transfer of a computer program from one place to another. The storage medium may be any available medium accessible to a computer. Examples of the computer-readable medium may include but are not limited to: a RAM, a ROM, an electrically erasable programmable read only memory (EEPROM), a compact disc read-only memory (CD-ROM) or another compact disc storage, a magnetic disk storage medium or another magnetic storage device, or any other medium that can be used to carry or store expected program code in a form of instructions or a data structure and that can be accessed by a computer. In addition, any connection may be properly defined as a computer-readable medium. For example, if software is transmitted from a website, a server, or another remote source by using a coaxial cable, an optical fiber, an optical cable, a twisted pair, a digital subscriber line (DSL), or a wireless technology such as infrared, radio, or microwave, the coaxial cable, the optical fiber, the optical cable, the twisted pair, the DSL, or the wireless technology such as infrared, radio, or microwave is included in a definition of a medium to which the coaxial cable, the optical fiber, the optical cable, the twisted pair, the DSL, or the wireless technology such as infrared, radio, or microwave belongs. For example, a disk (disk) and a disc (disc) used in embodiments of this application include a compact disc (CD), a laser disc, an optical disc, a digital video disc (DVD), a floppy disk, and a Blu-ray disc. The disk usually magnetically copies data, and the disc optically copies data in a laser manner. The foregoing combination should also be included in the protection scope of the computer-readable medium.

In conclusion, the foregoing descriptions are merely embodiments of this application and are not intended to limit the protection scope of this application. Any modification, equivalent substitution, improvement, and the like made based on the disclosure of this application shall fall within the protection scope of this application.

What is claimed is:

1. A timing advance determining method, comprising:
obtaining, first information about a reference time signal, wherein the reference time signal is a periodic signal;
determining, based on the first information, a reference time at which the reference time signal is generated; and
determining, a timing advance based on the reference time and a first time at which the first communication apparatus receives a downlink signal.

2. The method according to claim 1, wherein the first information comprises:
a period of the reference time signal; or
a first index useable to indicate the period of the reference time signal.

3. The method according to claim 2, wherein
the period of the reference time signal is greater than or equal to a first delay; and
the first delay is a transmission delay between the first communication apparatus and a second communication apparatus, or the first delay is a difference between a maximum value of the transmission delay between the first communication apparatus and the second communication apparatus and a minimum value of the transmission delay between the first communication apparatus and the second communication apparatus.

4. The method according to claim 1, wherein the period ΔT₁ₚₚₛ of the reference time signal satisfies a value of Num_SFN/(ΔT₁ₚₚₛ/L_SFN) being an integer, where Num_SFN is a quantity of system frames in one frame cycle, and L_SFN is a duration of a system frame of the system frames.

5. The method according to claim 4, further comprising:
receiving, second information, wherein the second information is useable to indicate the quantity of system frames in the one frame cycle.

6. A timing advance determining method, comprising:
determining, first information about a reference time signal, wherein the reference time signal is a periodic signal, and the first information is useable for determining a reference time at which the reference time signal is generated; and
sending, the first information.

7. The method according to claim 6, wherein the determining, the first information about the reference time signal comprises:
determining, a period of the reference time signal based on positional information between the second communication apparatus and a first communication apparatus and a first mapping, wherein the first mapping is a correspondence between the positional information and the period of the reference time signal.

8. The method according to claim 7, wherein the first information comprises:
the period of the reference time signal; or
a first index useable to indicate the period of the reference time signal.

9. The method according to claim 7, wherein
the period of the reference time signal is greater than or equal to a first delay; and
the first delay is a transmission delay between the first communication apparatus and the second communication apparatus, or the first delay is a difference between a maximum value of the transmission delay between the first communication apparatus and the second communication apparatus and a minimum value of the transmission delay between the first communication apparatus and the second communication apparatus.

10. The method according to claim 9, wherein the period ΔT₁ₚₚₛ of the reference time signal satisfies a value of Num_SFN/(ΔT₁ₚₚₛ/L_SFN) being an integer, where Num_SFN is a quantity of system frames in one frame cycle, and L_SFN is a duration of a system frame of the system frames.

11. A timing advance determining apparatus, comprising:
at least one processor, and one or more non-transitory memories coupled to the at least one processor, wherein the one or more non-transitory memories is configured to store programming instructions, and the at least one processor is configured to execute the programming instructions to thereby perform operations comprising:
obtaining, first information about a reference time signal, wherein the reference time signal is a periodic signal;
determining, based on the first information, a reference time at which the reference time signal is generated; and
determining, a timing advance based on the reference moment and a first time at which the first communication apparatus receives a downlink signal.

12. The apparatus according to claim 11, wherein the first information comprises:
a period of the reference time signal; or
a first index useable to indicate the period of the reference time signal.

13. The apparatus according to claim 12, wherein
the period of the reference time signal is greater than or equal to a first delay; and
the first delay is a transmission delay between the first communication apparatus and a second communication apparatus, or the first delay is a difference between a maximum value of the transmission delay between the first communication apparatus and the second communication apparatus and a minimum value of the transmission delay between the first communication apparatus and the second communication apparatus.

14. The apparatus according to claim 11, wherein the period ΔT₁ₚₚₛ of the reference time signal satisfies a value of Num_SFN/(ΔT₁ₚₚₛ/L_SFN) being an integer, where Num_SFN is a quantity of system frames in one frame cycle, and L_SFN is a duration of the system frame of the system frames.

15. The apparatus according to claim 14, wherein the operations further comprise:
receiving, second information, wherein the second information is useable to indicate the quantity of system frames in the one frame cycle.

16. A timing advance determining apparatus, comprising:
at least one processor, and one or more non-transitory memories coupled to the at least one processor, wherein the one or more non-transitory memories is configured to store programming instructions, and the at least one processor is configured to execute the programming instructions to thereby perform operations comprising:
determining, first information about a reference time signal, wherein the reference time signal is a periodic signal, and the first information is useable for determining a reference time at which the reference time signal is generated; and
sending, the first information.

17. The apparatus according to claim 16, wherein the determining, the first information about the reference time signal comprises:
determining, a period of the reference time signal based on positional information between the second communication apparatus and a first communication apparatus and a first mapping, wherein the first mapping is a correspondence between the positional information and the period of the reference time signal.

18. The apparatus according to claim 17, wherein the first information comprises:
the period of the reference time signal; or
a first index useable to indicate the period of the reference time signal.

19. The apparatus according to claim 18, wherein
the period of the reference time signal is greater than or equal to a first delay; and
the first delay is a transmission delay between the first communication apparatus and the second communication apparatus, or the first delay is a difference between a maximum value of the transmission delay between the first communication apparatus and the second communication apparatus and a minimum value of the transmission delay between the first communication apparatus and the second communication apparatus.

20. The apparatus according to claim 19, wherein the period ΔT₁ₚₚₛ of the reference time signal satisfies a value of Num_SFN/(ΔT₁ₚₚₛ/L_SFN) being an integer, where Num_SFN is a quantity of system frames in one frame cycle, and L_SFN is a duration of the system frame of the system frames.
